(19) United States
(12) Patent Application Publication
(10) Pub. No.: US 2015/0204535 A1
(43) Pub. Date: Jul. 23, 2015

(54) ELECTRIC HOME APPLIANCE

(71) Applicant: LG ELECTRONICS INC., Seoul (KR)

(72) Inventors: Hyesun JUNG, Changwon-si (KR); Hongseung Do, Changwon-si (KR)

(21) Appl. No.: 14/570,752

(22) Filed: Dec. 15, 2014

(30) Foreign Application Priority Data
Dec. 13, 2013 (KR) 10-2013-0155715

(51) Int. Cl. F21V 33/00; F21V 11/00

(52) U.S. Cl. CPC F21V 33/0044; F21V 11/00

(57) ABSTRACT

An electric home appliance is disclosed. The electric home appliance includes a light source and a panel having a light non-transmission region having a sufficient thickness not to transmit light emitted from the light source and at least one light transmission region having a thickness reduced by a depression formed at a rear of the panel upon which the light emitted from the light source is incident, the at least one light transmission region transmitting the light emitted from the light source, wherein at least a portion of the light source is disposed in the depression.

### CROSS-REFERENCE TO RELATED APPLICATION

This application claims priority under 35 U.S.C. §119 to Korean Application No. 10-2013-0155715 filed on Dec. 13, 2013, in the Korean Intellectual Property Office, whose entire disclosure of which is hereby incorporated by reference.

### BACKGROUND

1. Field

The present disclosure relates to an electric home appliance that visually displays an operation state of the electric home appliance through a panel.

2. Background

In general, an electric home appliance, such as a washing machine, a drying machine, a cooking appliance, a dish washing machine, or a water purifier, has a panel having a display unit for displaying an operation state of the electric home appliance. The display unit may include a visual display unit, such as a light emitting diode (LED) or a liquid crystal display (LCD), and an auditory display unit, such as a speaker or a buzzer.

The panel is generally provided with an installation hole, in which the display unit is installed. The display unit is supported in a state in which the display unit is installed in the installation hole. A gap may be provided between the display unit and the panel and moisture may be introduced into the electric home appliance through the gap or foreign matter may be caught in the gap.

In addition, the appearance of the display unit may always be recognized independently of the panel irrespective of the operation of the display unit based on functions thereof. In recent years, importance in design of the electric home appliance in terms of an aesthetically pleasing appearance as well as performance of the electric home appliance has been highlighted. However, it is difficult to provide a region at which the display unit is located with an aesthetically pleasing appearance unless the design of the display unit is improved.

Further, shielding force of the panel to components disposed at the rear of the panel may be changed based on a color to be realized. In order to obtain a panel having a desired optical property, therefore, it is necessary to change the design of the panel, which decides the shape of the panel, or the structural form of the panel. For example, an optical property, such as light transmissivity or a shielding property, is affected by the thickness of the panel as well as the color of the panel. In order to obtain a panel having a desired optical property, therefore, it is necessary to change the thickness of the panel based on a color. As a result, change in design of the panel or change of a manufacturing method of the panel is inevitable.

### BRIEF DESCRIPTION OF THE DRAWINGS

The embodiments will be described in detail with reference to the following drawings in which like reference numerals refer to like elements wherein:

FIG. 1 is a partial view showing a panel of an electric home appliance according to an embodiment of the present disclosure;

FIG. 2 is a sectional view showing a black panel as an example of the panel shown in FIG. 1 and a light source;

FIG. 3 shows sectional views showing a white or metal-colored panel as another example of the panel shown in FIG. 1 (shown on left side with label (a)); and a structure in which a light source is mounted in the panel (shown on right side with label (b)); and

FIG. 4 is a view showing a panel having a plurality of light transmission regions and a light source.

### DETAILED DESCRIPTION

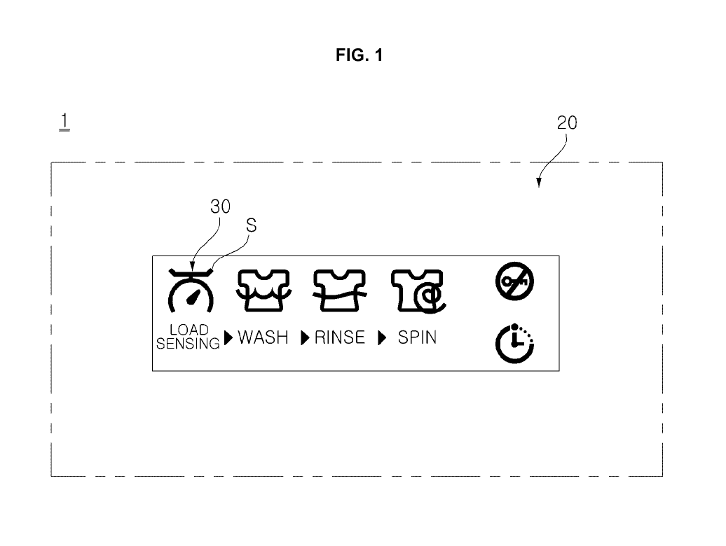

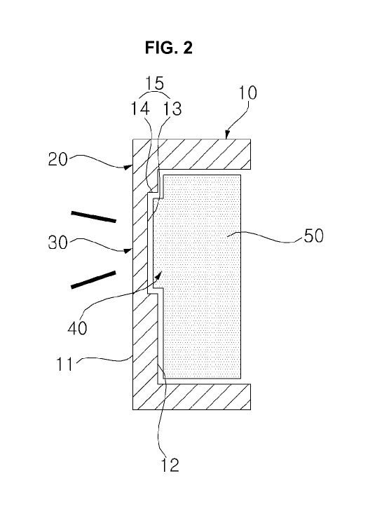

Referring to FIG. 1, an electric home appliance includes a panel 10 and a light source 40 (see FIG. 2). The panel 10 may be provided with a manipulation unit for allowing a user to manipulate the electric home appliance and a display unit for displaying an operation state of the electric home appliance. The light source 40, which is part of the display unit, is disposed at the rear of the panel 10 for emitting light. According to embodiments, the display unit may also function as the manipulation unit. For example, the display unit may include a sensor for sensing capacitance changed when a user touches a displayed region.

Signs S, such as symbols, letters, and figures, may be displayed on the panel 10 by printing, stamping, adhesion, etc. For example, FIG. 1 is a panel of a washing machine. Signs S including figures and letters for displaying operating processes, such as load sensing (LOAD SENSING), washing (WASH), rinsing (RINSE), and spin drying (SPIN), of the washing machine are shown in FIG. 1.

The light source 40 is covered by the panel 10. As a result, the light source 40 is not visible from the outside of the panel 10 in a state in which the light source 40 is off. In a state in which the light source 40 is on, on the other hand, light emitted from the light source 40 is transmitted through a predetermined region of the panel 10. The light emitted from the light source 40 toward the rear 12 of the panel 10 is transmitted through the panel 10 with the result that the signs S on the front 11 of the panel 10 become illuminated. A plurality of light sources 40 may be provided such that the light sources 40 can be assigned to the respective signs S.

Since the display unit, such as the light source 40, is not recognized from the outside of the panel 10 in a state in which the light source 40 is off and a display function is realized by light emitted from the light source 40 only in a state in which the light source 40 is on, the above structure will hereinafter be defined as a hidden display device.

In the hidden display device, it is not necessary to form an opening at the panel 10 such that the display unit is mounted in the opening. As a result, the surface of the panel 10 may be smooth. Consequently, it is possible to provide an aesthetically pleasing appearance and to fundamentally prevent introduction of moisture or foreign matter to the rear of the panel 10.

The panel 10 has a light non-transmission region 20 and at least one light transmission region 30. The light non-transmission region 20 has a sufficient thickness not to transmit light emitted from the light source 40. The panel 10 is provided at the rear 12 thereof with a depression 15. The light transmission region 30 is a region having a thickness less than that of the light non-transmission region 20 by the depression 15. The light transmission region 30 transmits light emitted from the light source 40.

The depression 15 includes a bottom 13 and a side 14. The bottom 13 and the side 14 constitute the rear 12 of the panel 10. The bottom 13 is a portion more adjacent to the front of the panel 10 than the light non-transmission region 20. The thickness of the panel 10 at the light transmission region 30 may be defined by the distance between the front of the panel 10 and the bottom 13.

The side 14 forms the thickness difference of the panel 10 between the light non-transmission region 20 and the light transmission region 30. The side 14 surrounds the light source 40.

At least a portion of the light source 40 is disposed in the depression 15. In the depression 15, the light source 40 may be disposed adjacent to the rear 12 of the panel 10 to the highest degree. Light emitted from the light source 40 is transmitted through the light transmission region 30 in the depression 15. However, it is necessary for the light emitted from the light source 40 to be transmitted through the side 14 of the depression 15 so as to reach the light non-transmission region 20. Consequently, a light shielding property of the light non-transmission region 20 is improved.

Light emitted from the light source 40 may be directly incident upon the rear 12 (i.e. the bottom 13 of the depression 15) of the panel 10 through a space defined in the depression 15. The light source 40 may be disposed adjacent to the rear 12 of the panel 10 to the highest degree such that a sufficient amount of light is incident upon the rear 12 of the panel 10. In this case, a pattern (hereinafter, referred to as ‘pattern light’) in which light emitted from the light source 40 is formed on the panel 10 may also be recognized in the front of the panel 10 without being changed. Even in a case in which the signs S are not formed on the panel 10, therefore, the pattern light may function as the signs.

Referring to FIG. 4, the at least one light transmission region 30 may include a first light transmission region 30(1) and a second light transmission region 30(2). On the assumption that a first light source 40(1), which is one of the light sources 40, is assigned to the first light transmission region 30(1) and a second light source 40(2), which is another of the light sources 40, is assigned to the second light transmission region 30(2), the first light source 40(1) may be disposed in the depression 15 in a state in which the first light source 40(1) is adjacent to the rear 12 of the panel 10 such that light emitted from the first light source 40(1) is transmitted through the first light transmission region 30(1) but is not transmitted through the second light transmission region 30(2). The same may be applied to the second light source 40(2).

Even in a case in which a plurality of light transmission regions 30 each having a thickness less than that of the light non-transmission region 20, dispersion of light is prevented by the depression 15 to a certain extent. As a result, light emitted from one light source 40(1) is transmitted only through the light transmission region 30(1) assigned to the light source 40(1) but is not transmitted through the light transmission region 30(2) assigned to another light source 40(2).

The light source 40 is mounted on a circuit board 60. For example, a circuit electrically connected to the light source 40, a drive unit 50 for controlling lighting of the light source 40, and a memory for storing a program for deciding a lighting pattern of the light source 40 may be mounted on the circuit board 60. A plurality of light sources 40 may be disposed on the circuit board 60. The light sources 40 may be turned on according to the lighting pattern stored in the memory under control of drive units 50 corresponding to the respective light sources 40. A plurality of drive units 50(1) and 50(2) may be provided. The drive units 50(1) and 50(2) may be mounted on the circuit board 60. In particular, as shown in FIG. 4, the light sources 40, the drive units 50, and the circuit board 60 may be sequentially stacked.

Referring to FIG. 2, the panel 10 may be formed by injection-molding a mixture of a light transmissive material, such as a resin material, and a paint. The panel 10 may have different colors based on colors of the added paint. The closer the color of the paint is to black, the more a shielding property of the panel 10 is improved. In a case in which the hidden display device is realized, therefore, it is possible to further reduce the thickness of the panel 10. Acrylonitrile butadiene styrene (ABS), polycarbonate (PC), or poly methyl methacrylate (PMMA) may be used as the light transmissive material.

In the light transmission region 30, the smaller the thickness of the panel 10 is, the more the light transmissivity of the panel is improved. However, it is necessary for the panel 10 to have a certain thickness in consideration of overall rigidity of the panel 10 and a shielding property of the panel 10 at the rear thereof in a state in which the light source 40 is off. For example, in a case in which the panel 10 is a black panel, the panel 10 may have a thickness of 1 to 1.2 mm at the light transmission region 30.

In a case in which the panel 10 is formed to have a black color, a shielding property of the panel 10 at the rear thereof is high due to optical properties of the color. Consequently, it is possible to realize the hidden display device only by adding a paint during injection molding of the panel 10 without an additional process. For a white or metal-colored (particularly, silver) panel, on the other hand, it is necessary to add a large amount of a paint such that the panel has a high light shielding property while providing a uniform color. In this case, the thickness of the light transmission region 30 of the white or metal-colored panel must be less than that of the light transmission region 30 of the black panel such that light emitted from the light source is transmitted through the light transmission region 30. As a result, it may be difficult to secure rigidity of the panel 10.

Furthermore, even in a case in which the white or metal-colored panel may be desired to be configured such that the white or metal-colored panel is identical in construction to the black panel 10 except for the color, it may not be possible to configure the white or metal-colored panel such that the white or metal-colored panel is identical in construction to the black panel 10 except for the color. In addition, it may be not possible to utilize manufacturing equipment, such as a mold, used to manufacture the black panel 10. As a result, change in design of the panel and change of manufacturing equipment or a manufacturing process of the panel may be inevitable.

Consequently, manufacturers who manufacture and sell electric home appliances having the same specifications and different colors so as to satisfy taste of consumers have disadvantages in terms of common use of parts and mass production. Hereinafter, a description will be given of a white or metal-colored panel that is capable of realizing a hidden display device without change in structure of the panel (for example, the white or metal-colored panel may have the same thickness as the black panel) as compared with the black panel 10 previously described with reference to FIG. 2.

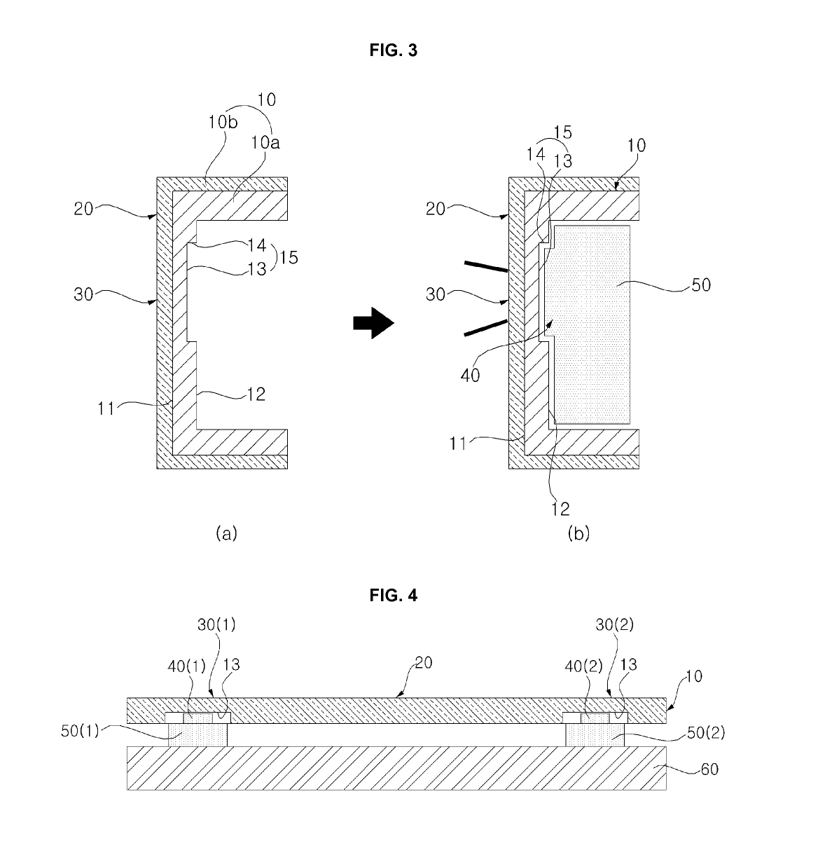

FIG. 3(a) is a sectional view showing a white or metal-colored panel as another example of the panel shown in FIG. 1 and FIG. 3(b) is a sectional view showing a structure in which a light source is mounted in the panel shown in FIG. 3(a). Referring to FIGS. 3(a) and 3(b), a panel 10 is formed by injection-molding a light transmissive material. The panel 10 includes a panel member 10a having a depression 15 and a coating layer 10b formed by applying a paint to the front of the panel member 10a. The coating layer 10b may have a predetermined thickness within a range in which light emitted from the light source 40 cannot be transmitted through the light non-transmission region 20 and light emitted from the light source 40 can be transmitted through the light transmission region 30.

A paint for realizing a white color may include a titanium oxide, such as TiO or TiO2. For a paint, a content ratio of a titanium oxide of which is 5.6 to 6.4%, the thickness of the coating layer necessary to realize the hidden display device may be 7 to 8 μm. In this case, it is possible to provide a vivid white color and to maintain the color of the light source 40 at the light transmission region 30.

Meanwhile, the panel member 10a may be made of a light transmissive material. In the same manner as the panel 10 of the previous embodiment, the panel member 10a may be formed by injection-molding ABS or PC. However, the panel member 10a is different from the panel 10 of the previous embodiment in that the panel member 10a is made of a pure resin having no paint added thereto and thus is transparent.

In order to realize the metal-colored panel 10, the coating layer 10b may be formed by applying a mirror coat material to the panel member 10a. The mirror coat material includes a high-luminance metallic light reflective component. In a case in which the mirror coat material is applied to the surface of an object, luminance of the surface of the object is improved due to a light reflection effect of the light reflective component. In particular, metallic material and color properties are obtained. Specifically, a silver color, such as aluminum or stainless steel, may be realized according to the light reflective component.

The mirror coat material exhibits a high light shielding property. For this reason, it may be necessary for the thickness of the coating layer 10b not to be too large so as to realize the hidden display device. Specifically, the thickness of the coating layer 10b of the metal-colored panel 10 may be less than that of the coating layer 10b of the white panel 10. For example, the coating layer 10b of the metal-colored panel 10 may have a thickness of 2 to 3 μm.

As is apparent from the above description, the electric home appliance according to the present disclosure has the effect of transmitting light emitted from the light source located at the rear of the panel through the light transmission region of the panel and positively shielding the light emitted from the light source at the light non-transmission region of the panel.

In addition, the electric home appliance according to the present disclosure has the effect of realizing the light transmission region and the light non-transmission region based on the simple structure using the thickness difference of the panel.

In addition, it is not necessary to change the shape of the panel although an optical property of the panel based on a color is changed. Consequently, the electric home appliance according to the present disclosure has the effect of providing high common usability of parts and improved productivity.

In addition, the electric home appliance according to the present disclosure has the effect of fundamentally preventing introduction of moisture or foreign matter through the panel.

In addition, the electric home appliance according to the present disclosure has the effect of transmitting light emitted from the light source only through one light transmission region assigned to the light source and preventing the light emitted from the light source from being transmitted through another light transmission region which is not assigned to the light source.

It is an object of the present disclosure to provide an electric home appliance that is capable of transmitting light emitted from a light source located at the rear of a panel through a light transmission region of the panel and positively shielding the light emitted from the light source at a light non-transmission region of the panel.

It is another object of the present disclosure to provide an electric home appliance that is capable of realizing a light transmission region and a light non-transmission region using a thickness difference of a panel.

It is another object of the present disclosure to provide an electric home appliance wherein it is not necessary to change the shape of a panel although an optical property of the panel based on a color is changed.

It is another object of the present disclosure to provide an electric home appliance that is capable of fundamentally preventing introduction of moisture or foreign matter through a panel.

It is a further object of the present disclosure to provide an electric home appliance that is capable of transmitting light emitted from a light source only through one light transmission region assigned to the light source and preventing the light emitted from the light source from being transmitted through another light transmission region which is not assigned to the light source.

In accordance with an aspect of the present disclosure, the above and other objects can be accomplished by the provision of an electric home appliance including a light source and a panel having a light non-transmission region having a sufficient thickness not to transmit light emitted from the light source and at least one light transmission region having a thickness reduced by a depression formed at a rear of the panel upon which the light emitted from the light source is incident, the at least one light transmission region transmitting the light emitted from the light source, wherein at least a portion of the light source is disposed in the depression.

The light emitted from the light source may be directly incident upon the rear of the panel through a space defined in the depression.

The at least one light transmission region may include a first light transmission region and a second light transmission region, and the light source may be disposed adjacent to a part of the rear of the panel defining the depression such that light emitted into first light transmission region is not transmitted through the second light transmission region.

The panel may be made of a mixture of a light transmissive resin and a paint. The panel may be formed by injection-molding the mixture of the light transmissive resin and the paint.

The paint may be black. The panel may have a thickness of 1 to 1.2 mm at the light transmission region.

The panel may include a panel member formed by injection-molding a light transmissive material, the panel member having the depression, and a coating layer formed by spraying a paint to a front of the panel member, and the coating layer may have a predetermined thickness within a range in which the light emitted from the light source cannot be transmitted through the light non-transmission region and the light emitted from the light source can be transmitted through the light transmission region. The paint may include TiO2, and the coating layer may have a thickness of 7 to 8 μm.

The paint may be a mirror coat material, and the coating layer may have a thickness of 2 to 3 μm.

The light transmissive material may be acrylonitrile butadiene styrene (ABS), polycarbonate (PC), or poly methyl methacrylate (PMMA).

The panel may have a thickness of 1 to 1.2 mm at the depression.

The thickness of the panel at the light transmission region may be defined by a distance between a bottom of the depression and a front of the panel. The thickness of the panel at the light non-transmission region may be defined by a distance between the front of the panel and a rear of the panel at a region other than the depression.

The depression may include a side extending from the bottom for surrounding the light source, and a thickness difference of the panel between the light transmission region and the light non-transmission region is formed by the side.

The panel may be provided at a part thereof corresponding to the light transmission region with a sign including at least one selected from among a symbol, a letter, and a figure. The sign may be formed at a front of the panel. The sign may be formed by printing, stamping, or adhesion.

The light source may be configured to form a pattern including at least one selected from among a symbol, a letter, and a figure on a rear of the panel.

The electric home appliance may further include a drive unit for driving the light source and a circuit board on which the drive unit is mounted, wherein the light source, the drive unit, and the circuit board may be sequentially stacked.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A display for a home appliance comprising:
a light source a first surface and a second surface, the front surface configured to emit light and the second surface being an opposite surface of the first surface; and
a panel made of a prescribed material and having a front surface and a rear surface, the panel including at least one light transmission area configured to provide information regarding at least one operation of a home appliance and a light non-transmission area, and a first thickness between the front surface and the rear surface of the panel at the at least one light transmission area being less than a second thickness between the front surface and the rear surface of the panel at the non-transmission, wherein
a thickness difference between the first and second thicknesses being provided by a recess formed on the rear surface of the panel, and
at least the first surface the light source is provided in the recess at the rear surface of the panel such that the light emitted from the first surface of the light source travels through the first thickness of the panel while the second thickness prevent light transmission.

2. The display for a home appliance according to claim 1, wherein the light emitted from the first surface of the light source is directly incident upon the rear of the panel at the recess.

3. The display for a home appliance according to claim 2, wherein the at least one light transmission area comprises a first light transmission area and a second light transmission area, and the light non-transmission area is provided between the first and second light transmission areas such that light emitted by the light source at the first light transmission area does not reach the second light transmission area.

4. The display for a home appliance according to claim 1, wherein the panel is made of a mixture of resin and paint.

5. The display device for a home appliance according to claim 4, the mixture resin and paint is injection molded to form the panel.

6. The display for a home appliance according to claim 4, wherein the paint is black.

7. The display for a home appliance according to claim 6, wherein the first thickness of the light transmission area for the panel is 1 to 1.2 mm.

8. The display for a home appliance according to claim 1, wherein the panel comprises an injection molded light transmissive layer and a coating layer of paint over the injection molded light transmissive layer, wherein the coating layer has a predetermined thickness such that light emitted from the light source is prevented from transmitting through the light non-transmission area and the light emitted from the light source is transmitted through the light transmission area.

9. The display for a home appliance according to claim 8, wherein the paint comprises TiO₂, and the predetermined thickness of the coating layer is 7 to 8 μm.

10. The display for a home appliance according to claim 8, wherein the paint comprises a mirror coat material, and the predetermined thickness of the coating layer is 2 to 3 μm.

11. The display for a home appliance according to claim 8, wherein the injection molded light transmissive layer is at least one of acrylonitrile butadiene styrene (ABS) layer, polycarbonate (PC) layer, or poly methyl methacrylate (PMMA) layer.

12. The display for a home appliance according to claim 1, wherein the first thickness of the panel at the light transmission area has a thickness of 1 to 1.2 mm.

13. The display for a home appliance according to claim 1, wherein the first thickness of the panel at the light transmission area corresponds to a distance between a bottom surface of the recess and the front surface of the panel.

14. The display for a home appliance according to claim 13, wherein the second thickness of the panel at the light non-transmission area corresponds a distance between the front surface of the panel and the rear surface of the panel where the recess is absent.

15. The display for a home appliance according to claim 14, wherein the recess includes a side extending from a bottom to surround the first surface of light source, and the thickness difference of the panel between the light transmission area and the light non-transmission area corresponds to a height of the side.

16. The display for a home appliance according to claim 1, wherein the information regarding at least one operation of a home appliance comprises a sign, the sign including at least one of a symbol, a letter, or a figure.

17. The display for a home appliance according to claim 16, wherein the sign is provided at the front surface of the panel and the front surface of the panel serves as an exterior surface of a home appliance.

18. The display for a home appliance according to claim 17, wherein the sign is provided on the front surface by printing, stamping, or adhesion.

19. The display for a home appliance according to claim 1, wherein the light source is configured to form a pattern comprising at least one of a symbol, a letter, or a figure at a rear of the panel.

20. The display for a home appliance according to claim 19, further comprising:
a drive module configured to drive the light source; and
a circuit board on which the drive module is mounted, wherein the light source, the drive unit, and the circuit board are stacked sequentially.
